(19) United States
(12) Patent Application Publication
(10) Pub. No.: US 2023/0421979 A1
(43) Pub. Date: Dec. 28, 2023

(54) AUDIO DECORRELATOR, PROCESSING SYSTEM AND METHOD FOR DECORRELATING AN AUDIO SIGNAL

(71) Applicant: Fraunhofer-Gesellschaft zur Förderung der angewandten Forschung e.V., München (DE)

(72) Inventors: Sascha DISCH, Erlangen (DE); Carlotta ANEMÜLLER, Erlangen (DE); Jürgen HERRE, Erlangen (DE)

(21) Appl. No.: 18/462,892

(22) Filed: Sep. 7, 2023

Related U.S. Application Data
(63) Continuation of application No. PCT/EP2022/055983, filed on Mar. 9, 2022.

(30) Foreign Application Priority Data
Mar. 11, 2021 (EP) 21162142.0
Oct. 20, 2021 (EP) 21203832.7

(51) Int. Cl. H04S 7/00; G10L 19/26; H04S 1/00

(52) U.S. Cl. CPC H04S 7/301; G10L 19/26; H04S 1/007; H04S 2400/01

(57) ABSTRACT

A decorrelator includes a plurality of delay units, wherein each delay unit is configured for receiving a part of a frequency representation being based on an audio signal, wherein each delay unit is configured for delaying the received part to provide a delayed part. The decorrelator includes an envelope shaper configured for receiving and combining signals being based on the delayed parts of the frequency representation. The envelope shaper receives the frequency representation of the audio signal and is configured for adjusting an energy of the delayed parts in respect of the frequency representation of the audio signal. The envelope shaper is configured for providing a combined shaped frequency representation. Transient signal portions are handled by an adapted operation of the decorrelator.

This application is a continuation of copending International Application No. PCT/EP2022/055983, filed Mar. 9, 2022, which is incorporated herein by reference in its entirety, and additionally claims priority from European Applications Nos. EP 21 162 142.0, filed Mar. 11, 2021, and EP 21 203 832.7, filed Oct. 20, 2021, all of which are incorporated herein by reference in their entirety.

### BACKGROUND OF THE INVENTION

The present invention relates to a decorrelator for an audio signal, to a processing system having such a decorrelator, to a decorrelation method and to a computer program product. The present invention in particular relates to an audio signal decorrelator.

In perceptual audio coding, decorrelators are an important building block for parametric spatial audio coding. Known solutions relate to decorrelators known from parametric spatial audio coding like parametric stereo or MPEG surround. Decorrelators as described in [1] or [2] use computationally costly time domain reverberation (reverb) filters with a long impulse response. Decorrelators such as described in [3] or [4] require the use of a Quadrature Mirror Filterbank (QMF) with considerable processing delay and computationally expensive Lattice filters.

There is, thus, a need for a decorrelator, a processing system having such a decorrelator and a method for decorrelating portions of an audio signal allowing for a low processing delay and/or low computational complexity decorrelation.

### SUMMARY

An embodiment may have a decorrelator comprising: a plurality of delay units, wherein each delay unit is configured for receiving a part of a frequency representation being based on an audio signal; wherein each delay unit is configured for delaying the received part to provide a delayed part; and an envelope shaper configured for receiving and combining signals being based on the delayed parts of the frequency representation; for receiving the frequency representation of the audio signal; for adjusting an energy of the delayed parts in respect of the frequency representation of the audio signal; and for providing a combined shaped frequency representation.

Another embodiment may have a processing system comprising: a decorrelator according to claim 1; and a processing stage for transforming a mid/side decomposed signal to a left/right decomposed signal.

Another embodiment may have a method comprising: receiving a plurality of parts of a frequency representation being based on an audio signal; delaying each of the received parts to provide a plurality of delayed parts; and receiving and combining signals being based on the delayed parts of the frequency representation; receiving the frequency representation of the audio signal; adjusting an energy of the delayed parts in respect of the frequency representation of the audio signal; and providing a combined shaped frequency representation.

Another embodiment may have a non-transitory digital storage medium having a computer program stored thereon to perform the method comprising: receiving a plurality of parts of a frequency representation being based on an audio signal; delaying each of the received parts to provide a plurality of delayed parts; and receiving and combining signals being based on the delayed parts of the frequency representation; receiving the frequency representation of the audio signal; adjusting an energy of the delayed parts in respect of the frequency representation of the audio signal; and providing a combined shaped frequency representation, when said computer program is run by a computer.

A finding of the present invention is that dividing a frequency representation in a plurality of parts and for processing, i.e., delaying each of the parts with a separate delay unit, allows for a low processing delay, as the computational the different parts may be performed in parallel. As the same time, such frequency domain operations require a low computational complexity.

According to an embodiment, a decorrelator comprises a plurality of delay units, wherein each delay unit is configured for receiving a part of a frequency representation being based on an audio signal, wherein each delay unit is configured for delaying the received part to provide a delayed part. The decorrelator comprises an envelope shaper configured for receiving an combining signals being based on the delayed parts of the frequency representation, for receiving the frequency representation of the audio signal, for adjusting an energy of the delayed parts in respect of the frequency representation of the audio signal and for providing a combined shape frequency representation.

According to an embodiment, different parts of the frequency representation comprise a same or a different number of frequency bins. Wherein a same number of frequency bins may allow for a same processing time, a different number of frequency bins may allow for an adaptation towards application requirements.

According to an embodiment, the decorrelator comprises a phase shifter configured for phase shifting the frequency representation of the audio signal, or for phase shifting the audio signal in a time domain to obtain a phase shifted audio signal. Phase shifting may allow for a perceived reverberation and therefore for a high audio quality.

According to an embodiment, the phase shifter is configured for a phase shifting the frequency representation of the audio signal and comprises a plurality of Allpass filters, wherein each Allpass filter is configured for phase shifting an associated part of the frequency representation of the audio signal. That is, the Allpass filter may be associated and adapted towards the respective part of the audio signal which may allow for a high overall audio quality.

According to an embodiment, an Allpass filter of the plurality of Allpass filters comprises a set of Allpass filter structures being serially connected to each other, i.e., using Schroeder IIR filters. The Allpass filter structures are adapted for providing different time delays. Alternatively or in addition, the Allpass filter structures comprise a nested Allpass filter structure.

According to an embodiment, a number of Allpass filter structures and/or a circuitry of the Allpass filter structure is equivalent or different between different Allpass filters. This allows for a high flexibility of the decorrelator.

According to an embodiment, the different time delays are based on a prime number multiple of a local sampling rate used for obtaining the frequency representation of the audio signal. This allows for a high perceived audio quality.

According to an embodiment, the set of Allpass filter structures comprises a number of four Allpass filter structures and are adapted for providing a delay of 1, 2, 3 and 5 time units. Such a time unit may be based on a blocksize of the conversion into the frequency domain. For example, using a blocksize of 256 with 50% overlap, a time unit may result in 128 samples@48 kHz=2.7 ms. Reasonable other time units may be, for example, 32 or 64 samples or other values. The time units are advantageously short enough to allow for sufficient time resolution in the subsequent time/frequency envelope shaping. In an alternative solution, a delay of 1, 3, 5 and 7 is provided by the four Allpass filter structures. This allows to avoid overlaps in the time domain.

According to an embodiment, a gain factor of the Allpass filter is adapted to a value with a magnitude, i.e., positive or negative values, of 0.7 within a tolerance range. The tolerance range is, for example, 20%, 10% or 5%.

According to an embodiment, the phase shifter is configured for phase shifting the audio signal in a time domain, wherein the phase shifter comprises a set of Allpass filter structures being serially connected to each other, wherein the Allpass filter structures are adapted for providing different time delays. Alternatively or in addition, the Allpass filter structures comprise a nested Allpass filter structure.

According to an embodiment, the different Allpass time delays are based on a prime number multiple of a reciprocal of a sampling rate used for obtaining the frequency representation of the audio signal. Like in the frequency domain, a corresponding advantage may also be obtained in the time domain. In the time domain, different time delays may be based on a prime number being obtained by multiplying each of a set of minimal prime numbers, e.g., 1, 2, 3 and 5 as one example set or 1, 3, 5 and 7 as another example set with a downsampling factor used for generating the parts of the frequency representation of the audio signal to obtain an intermediate result and for using a next prime number with respect to the intermediate result. As a next prime number a closest distance may be understood, e.g., to obtain the next larger or next smaller prime-value. In the given example, the values 131, 257, 383 and 641 may be obtained for the first set and 131, 383, 641 and 907 may be obtained for the second example set. Here, one time unit may be 1 sample. The sample may relate to a sampling frequency being, e.g., 48 kHz. In other embodiments, sampling frequency can also be 44.1 kHz or 32 kHz or other values.

According to an embodiment, the decorrelator comprises a first conversion unit for obtaining the frequency representation of the audio signal from the audio signal for the envelope shaper and comprising a second conversion unit for obtaining a frequency representation from the reverberated audio signal, wherein the parts of the frequency representation form parts of the frequency representation from the reverberated audio signal. This allows to generate the used signal formed directly at the decorrelator.

According to an embodiment, the decorrelator is adapted for additionally implementing a same and predefined delay for a subset or all parts of the frequency representation. That is, a delay that is equal for the respective parts or delay lines may also be applied commonly in a common delay module which allows for simple delay units in the respective delay lines for an associated part.

According to an embodiment, the delay units associated to a spectral part of the plurality of delay units are configured for delaying the associated part of the frequency representation differently when compared to delay units associated to other spectral parts. This allows for a high perceived quality by treating different frequency portions differently.

According to an embodiment, the delay unit is configured for delaying parts of the frequency representation comprising lower frequencies with a higher time delay when compared to parts of the frequency representation comprising higher frequencies.

According to an embodiment, a relationship between different time delays is linear, logarithmic and/or based on a rounding on subband samples. This allows for a high perceived quality.

According to an embodiment, the decorrelator comprises a conversion unit for receiving an converting the audio signal or a reverberated version of the audio signal into the parts by performing a time-block-wise discrete Fourier transform, DFT, or short-time Fourier transform, STFT, wherein the conversion unit is configured for converting blocks having an overlap of 50% within a tolerance range. Such block-wise conversion allows for short delays for a respective part being obtained and for a parallel treatment of the different parts.

According to an embodiment, the envelope shaper is configured for operating in a subband domain and with a temporal resolution of less than 4 milliseconds.

According to an embodiment, the decorrelator comprises a signal processing stage configured for receiving a signal based on the combined shaped frequency representation, e.g., as a mono signal, and for processing the mono signal at least to a stereo signal. This allows for an improved perception of a listener.

According to an embodiment, the decorrelator comprises a signal processing stage configured for processing the combined shaped frequency representation at least to a stereo signal and for source extent modelling based on the at least stereo signal, e.g., in the frequency domain.

According to an embodiment, a processing system comprises a decorrelator as described herein and a processing stage for transforming a mid/side decomposed signal to a left/right decomposed signal.

According to embodiments, the processing system may perform transient suppression to suppress echoes, e.g., pre-echoes and/or post-echoes caused by a transient. Such a transient handling may comprise muting the output of a decorrelator and, correspondingly, amplifying an output of a delay compensation unit providing for a portion of the left/right decomposed signal and being in parallel with the decorrelator and connected with the processing stage.

According to an embodiment, a method comprises receiving a plurality of parts of a frequency representation being based on an audio signal, delaying each of the received parts to provide a plurality of delayed parts and receiving and combining signals being based on the delayed parts of the frequency representation. The method comprises receiving the frequency representation of the audio signal and adjusting an energy of the delayed parts in respect of the frequency representation of the audio signal. A combined shaped frequency representation is provided.

According to an embodiment, a computer program or computer program product or a non-transitory storage medium having stored therein instructions to carry out respective instructions is provided for executing such a method, when running on a computer.

### BRIEF DESCRIPTION OF THE DRAWINGS

Embodiments of the present invention will be detailed subsequently referring to the appended drawings, in which:

FIG. 1 shows a schematic block diagram of a decorrelator according to an embodiment;

FIG. 2 shows a schematic block diagram of a decorrelator comprising a conversion unit for generating a frequency representation of a time-domain signal according to an embodiment;

FIG. 3 shows a schematic block diagram of a decorrelation additionally comprising a pre-delay according to an embodiment;

FIG. 4 shows a schematic block diagram of an Allpass filter according to an embodiment;

FIG. 5 shows a schematic block diagram of a nested Allpass filter structure according to an embodiment;

FIG. 6 shows a schematic block diagram of a decorrelator comprising a phase shifter configured to operate in the time domain according to an embodiment;

FIG. 7 shows a schematic block diagram of a decorrelator being connected to a source extend modelling according to an embodiment;

FIG. 8 shows a schematic block diagram of a processing system according to an embodiment;

FIG. 9 shows a schematic block diagram of a processing system configured for transient handling according to an embodiment; and

FIG. 10 shows a schematic block diagram of a method according to an embodiment.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present invention. However, it will be apparent to those skilled in the art that embodiments of the present invention may be practiced without these specific details. In other instances, well known structures and devices are shown in block diagram form rather than in detail in order to avoid obscuring embodiments of the present invention. In addition, features of the different embodiments described hereinafter may be combined with each other, unless specifically noted otherwise.

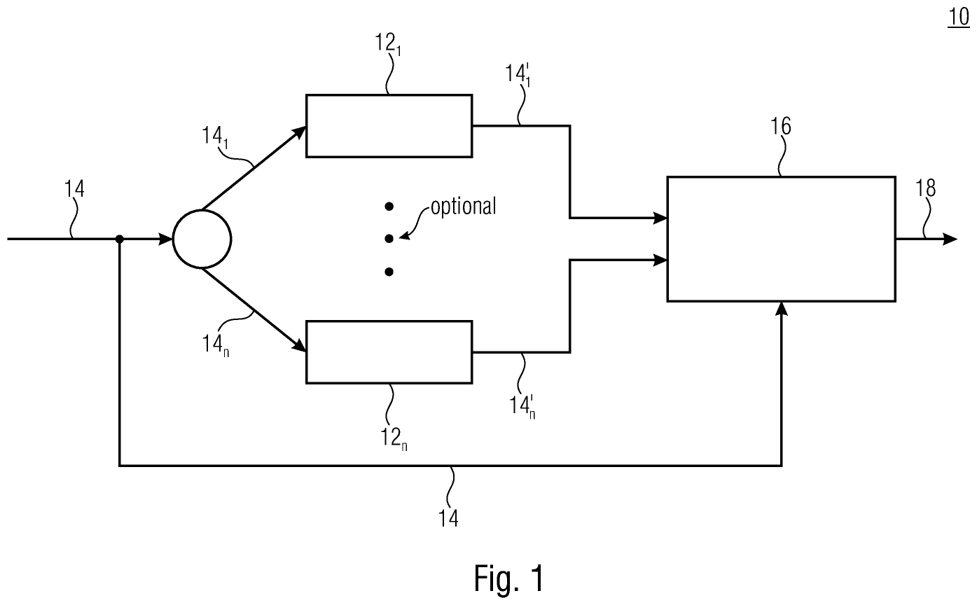

FIG. 1 shows a schematic block diagram of a decorrelator 10 according to an embodiment. Decorrelator 10 comprises a number of at least two delay units 12₁ to 12ₙ with n>1. Although FIG. 1 illustrates a number of two delay units 12, the number is advantageously higher, e.g., 4, 8, 16 or other values to be obtained with a power of 2, wherein embodiments are not limited to such numbers. That is, embodiments may also comprise a number of 3, 5, 7 or 9 delay units 12. Each delay unit is configured for receiving an associated part 14₁ to 14ₙ of a frequency representation 14 being based on an audio signal. For example, the frequency representation 14 may be or may comprise a spectrum being obtained by a Fourier Transform such as a discrete Fourier Transform, DFT, or a short term Fourier transform, STFT. The parts 14₁ to 14ₙ may be obtained, for example, as a subband of the spectrum, i.e., a part of the frequency domain representation. For example, such a part 14₁ to 14ₙ may be obtained by using an appropriate window.

Each delay unit 12₁ to 12ₙ is configured for delaying the received part 14₁ to 14ₙ so as to provide a delayed part 14′₁ to 14′ₙ, i.e., for having a delay in the time domain.

The decorrelator 10 further comprises an envelope shaper 16 configured for receiving signals being based on the delay parts 14′₁ to 14′ₙ. Such signals may be the delayed parts 14′₁ to 14′ₙ themselves or processed variants thereof. The envelope shaper 16 is configured for combining the received signals. In addition, the envelope shaper is configured for receiving the frequency representation 14 of the audio signal. The envelope shaper 16 is configured for adjusting an energy of the delayed parts 14′₁ to 14′ₙ in respect of the frequency representation 14 of the audio signal. The envelope shaper 16 is configured for providing a combined shaped frequency representation 18. In the combined shaped frequency representation 18, the respective parts 14₁ to 14ₙ, signals resulting thereof respectively, may be decorrelated with regard to one another and/or with regard to the frequency representation 14.

Although the envelope shaper 16 is illustrated so as to receive the combined frequency representation 14, as an alternative, the envelope shaper 16 may receive the respective information by receiving the possibly non-delayed or commonly treated parts 14₁ to 14ₙ.

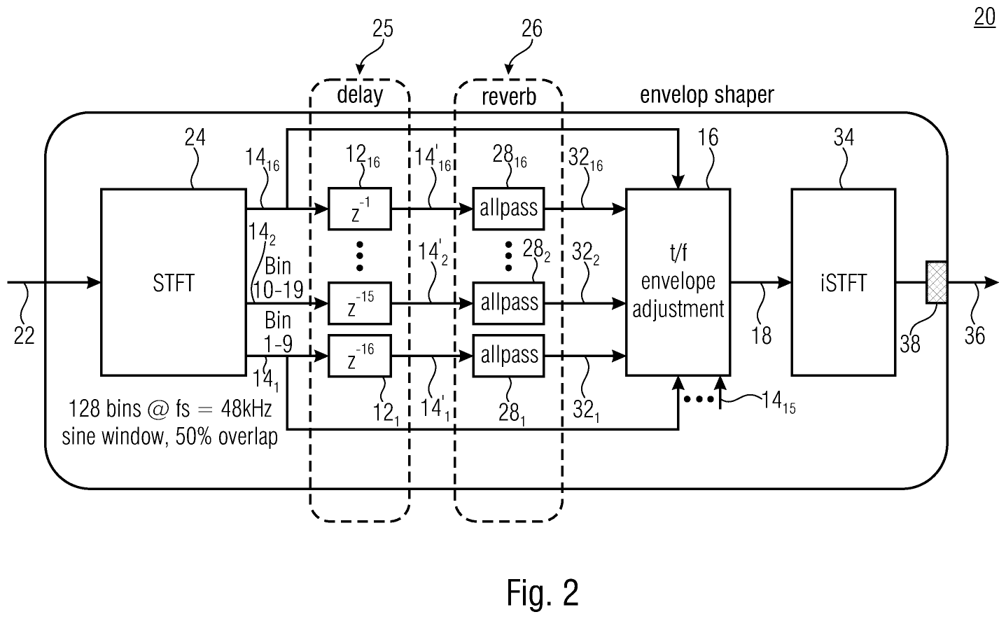

FIG. 2 shows a schematic block diagram of a decorrelator 20 according to an embodiment. The decorrelator 20 is configured for receiving an audio signal 22. The decorrelator 20 may comprise a conversion unit 24 configured for generating the frequency representation 14 shown in FIG. 1. The conversion unit 24 may provide for parts 14₁ to 14₁₆ being obtained by an example STFT. For example, the frequency representation may comprise a number of 129 frequency bins in total. Alternatively, 128 bins may be used. For example, two types of Digital Fourier Transforms (DFT) may be used, a so-called “evenly stacked” and an “oddly stacked”. For example, as “standard” DFT the evenly stacked version may be considered having, in the example provided, 129 bands (127 complex, one real and one imaginary). The oddly stacked may comprise 128 (complex) bands. Both transforms can be used in embodiments described herein. The parts 14₁ to 14₁₆ may comprise, partly or completely, a same or different number of bins. For example, part 14₁ may comprise the first to the ninth bin, e.g., 9 bins. Part 14₂ comprises, for example, bins 10 to 19 and, thus, a number of ten bins. The adaptation or selection with regard to the number of bins may be based on the sampling frequency being in the illustrated example 48 kHz, the overlap that is, for example, 50% and/or a number of parts 14₁ to 14₁₆ to be generated. The parts 14₁ to 14₁₆ may comprise an equal or different number of frequency bins such that some or all parts 14₁ to 14₁₆ may also be generated so as to comprise a same number of frequency bins.

The decorrelator 20 further comprises a delay section 25 having delay lines 12₁ to 12₁₆, each delay line 12₁ to 12₁₆ being associated with one specific part 14₁ to 14₁₆ and configured for receiving said part, a processed version thereof respectively. The delay units 12₁ to 12₁₆ may be associated to a respective spectral part 14₁ to 14₁₆. Such a delay unit 12₁ to 12₁₆ may be configured for delaying the associated part of the frequency representation 14 differently when compared to delay units associated to other spectral parts. Alternatively or in addition, a relationship between different time delays may be one of linear, logarithmic and/or based on a rounding on super band samples.

The decorrelator 20 further comprises a phase shifter 26 being coupled to the delay section 25, the phase shifter 26 configured for receiving the delayed parts 14′₁ to 14′₁₆. Phase shifting using the phase shifter 26 may allow for a reverberation in the signal parts. However, according to embodiments, a sequence of the delay section 25 and the reverberation section 26 may also be changed such that a respective part 14₁ to 14₁₆ may first be subject of a reverberating filter and afterwards being delayed.

The phase shifter 26 may be configured for phase shifting the frequency representation 14 of the audio signal, a processed, e.g., delayed, version thereof. The phase shifting may also be performed prior to converting the audio signal 22 into the frequency domain, a corresponding phase shifter may be configured for phase shifting the audio signal 22 in the time domain to obtain a phase shifted audio signal. In the short configuration where the phase shifter 26 is configured for phase shifting the frequency representation of the audio signal 14, the delayed version thereof respectively, the phase shifter may comprise a plurality of Allpass filters 28₁ to 28₁₆. In the shown example, the Allpass filters 28₁ to 28₁₆ are configured to receive the delayed parts 14′₁ to 14′₁₆. The term Allpass filter is to be understood that the frequency range to be passed corresponds to the frequency range of the respective part 14₁ to 14₁₆. Wherein this may include examples where each of the Allpass filters 28₁ to 28₁₆ passes the complete frequency range provided in the frequency representation, the passband of different Allpass filters 28₁ to 28₁₆ may also differ from one another based on the different frequency bins contained in the respective parts 14₁ to 14₁₆.

Each of the Allpass filters 28₁ to 28₁₆ is configured for phase shifting an associated part of the frequency representation of the audio signal.

That is, a number of Allpass filter structures and/or a circuitry of the Allpass filter structure may be the same, i.e., equal or comparable, or may, alternatively, be different between different Allpass filters 28₁ to 28₁₆.

A time delay provided by the delay lines 12₁ to 12₁₆ may be same or may be different for different parts 14₁ to 14₁₆. As indicated in FIG. 2, parts of the frequency representation comprising lower frequencies may be delayed with a higher time delay when compared to parts of the frequency representation comprising higher frequencies. From bin 1 to higher bins, a represented frequency may increase. As represented in the z-domain, the time delay may decrease with an increase of frequencies.

Signals 32₁ to 32₁₆ may comprise a result of the delaying and the phase shifting, e.g., as an output of the Allpass filters 28₁ to 28₁₆.

The envelope shaper 16 may be configured for receiving signals 32₁ to 32₁₆ and an unfiltered and undelayed version thereof, i.e., the parts 14₁ to 14₁₆, i.e., the frequency representation of the audio signal 22. The parts 14₁ to 14₁₆ may be understood as subbands. The envelope shaper 16 may be configured for operating in a subband domain. For example, a temporal resolution of the envelope shaper 16 may be at most or less than 4 milliseconds, e.g., 4 milliseconds, 3.5 milliseconds, 3 milliseconds or less.

The decorrelator 20 may comprise another conversion unit 35 that may provide for an inverse operation when compared to the conversion unit 24. For example, the conversion rate 34 may perform an inverse short term Fourier transform iSTFT. The combined shape frequency representation 18 may comprise information with regard to the frequency domain that is present in each of the bins such that the combined shaped frequency representation 18 may be treated correspondingly to the output of the conversion unit 24. That is, the conversion unit 34 may receive the processed versions of the parts 14₁ to 14₁₆ of the frequency representation 14 and for synthesizing a synthesized signal 36 from the processed versions 14′₁ to 14′₁₆ based on, e.g., an overlap-add procedure. The signal 36 may be provided, for example, at an interface 38 of the decorrelator 20.

The envelope shaper 16 may be configured for shaping spectral bins in time and/or frequency. Shaping may be performed by the envelope shaper 26 for individual bins and/or for groups of bins, e.g., by implementing an interdependent or an at least groupwise common shaping processing.

When referring again to conversion unit 24, same may be configured for receiving and converting the audio signal 22 or a reverberated version thereof into the parts 14₁ to 14₁₆, wherein the number of 16 is an example only. The reverberated version of the audio signal 22 may be an input in case the phase shifter 26 operates in the time domain and may thus be arranged upstream of the conversion unit 24. The conversion unit 24 may perform a time-block-wise discrete Fourier transform, DFT, or a short-time Fourier transform, STFT. The conversion unit may be configured for converting blocks having an overlap of, e.g., 50% within a tolerance range. For example, the tolerance range may be 0% as far as possible, at most 5%, at most 10%, at most 15% or more.

The blocks may comprise a block length of, for example, 128 samples, 256 samples or 512 samples, wherein a value of 256 may be advantageous.

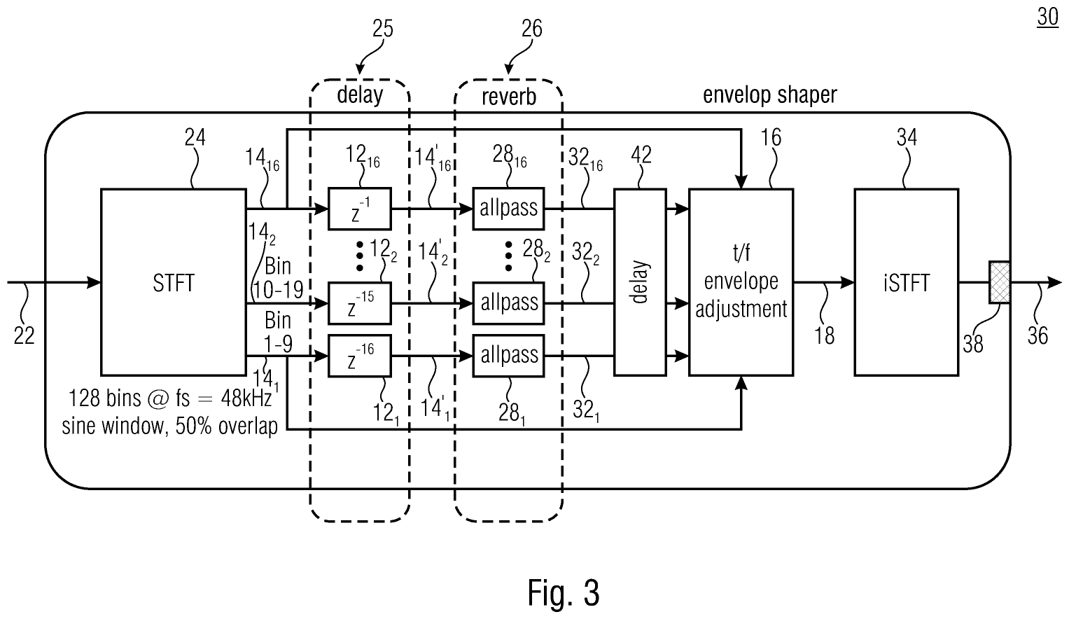

FIG. 3 shows a schematic block diagram of a decorrelation 30. When compared to the decorrelator 20, the decorrelator 30 may additionally comprise a pre-delay 42, wherein the term pre-delay does not limit the delay to be implemented directly prior or subsequent to any specific block. The pre-delay 42 may be located at any stage prior to the envelope shaper 16, advantageously and when operating in the frequency domain, after the conversion unit 24. That is, for example, a sequence between the Allpass filters of the reverberation or phase shifter 26 and the pre-delay 42 may be swapped when compared to the illustration in FIG. 3. The pre-delay 42 or the delay block 42 may be configured to additionally implement a same and predefined delay for a subset or all of the parts 14₁ to 14₁₆ of the frequency representation. This may allow for implementing the same delay to each part 14₁ to 14₁₆ or a group thereof for combining the processing at this stage and to use delay lines 12₁ to 12₁₆ for adding a probably individual delay to differ from the common delay implemented in block 42. In one example, the pre-delay 42 is configured to allow for a constant pre-delay for all spectral bands.

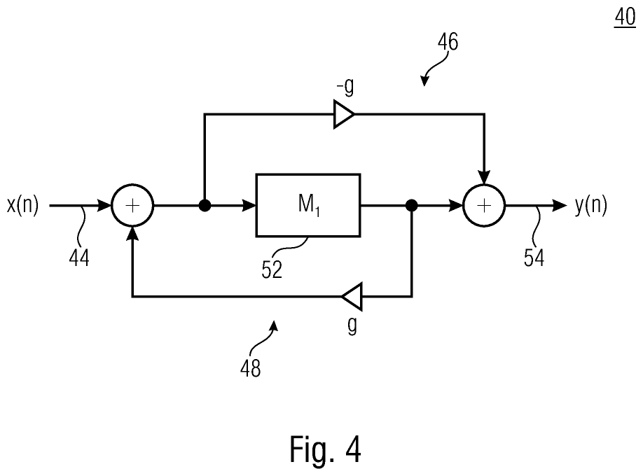

FIG. 4 shows a schematic block diagram of an Allpass filter 40 according to an embodiment that may be operated at least as a part of one of filters 28₁ to 28₁₆ of decorrelator 20 and/or 30. Allpass 40 may comprise a structure of a Schroeder IIR filter, for example, and may comprise a forward branch 46 in combination with a backward branch 48 in combination with a delay block 52 to provide for a respective output signal 54 being based on an input signal 44 of the Allpass filter 40. An Allpass filter 28 of decorrelator 20 and/or 30 may comprise one or more of such Allpass filters 40 being connected serially to one another. To provide for different time delays in different Allpass filters 28₁ to 28₁₆, a different number of Allpass filter structures 14 may be serially connected.

In other words, FIG. 4 shows an Allpass filter stage.

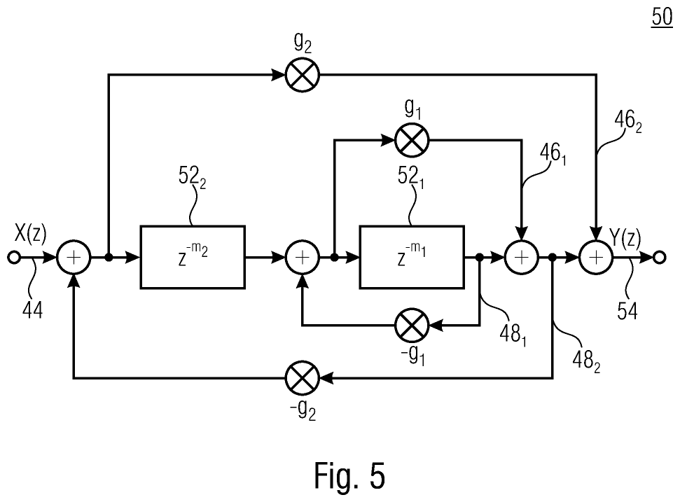

FIG. 5 shows a schematic block diagram of an Allpass filter structure 50 being a nested Allpass filter structure. Alternatively or in addition to Allpass filter structure 40, one or more Allpass filter structures 50 may form at least a part of an Allpass filter 28₁ to 28₁₆ of the decorrelator 20 and/or 30. Although showing two delay blocks 52₁ and 52₂, a different and especially higher number of delay blocks 52 may be present resulting possibly in an increased number of forward branches 46 and/or backward branches 48. Further, gains g₁/−g₁ and/or g₂/−g₂ may be adopted.

When considering, for example, to serially connect delay blocks 52 in one or more Allpass filter structures 40 and/or one or more Allpass filter structures 50, different Allpass filters 28₁ to 28₁₆ may be implemented so as to comprise a different time delay when compared to other Allpass filters. For example, the different delays of different Allpass filter structures and/or circuitries of Allpass filter structures may be based on a prime number multiple of a local sampling rate, e.g., 48 kHz, used for obtaining the frequency representation 14 of the audio signal 22. For example, a set of Allpass filter structures forming at least a part of an Allpass filter may comprise a number of four Allpass filter structures, e.g., Allpass filter structures 40. The different delay blocks therein may be adapted for providing a delay of 1, 2, 3 and 5. According to a different example, the number of four Allpass filter structures may provide a delay of 1, 3, 5 and 7 units in the z-domain. Those values may form a set of prime values, i.e., a number of 2, 3, 4, 5 or more prime values may be grouped.

When transferring this embodiment, the sets of prime values respectively, to the possible operations of the Allpass filters in the time domain, the time delays are based on a prime number multiple of a reciprocal of a sampling rate used for obtaining the frequency representation of the audio signal in an embodiment. For example, the different time delays may be based on a prime number being obtained by multiplying each of a set of prime numbers as mentioned, for example, 1, 2, 3 and 5 or 1, 3, 5 and 7 with a down sampling factor used for generating the parts of the frequency representation of the audio signal to obtain an intermediate result. Instead of the intermediate result, a next prime number with respect to the intermediate result may be used. For example, when referring to the downsampling factor of 128 and considering the sets of prime numbers above, such a result may be the delay of 131, 257, 383 and 641 on the one hand and 131, 383, 641 and 907 on the other hand, wherein each delay may relate to a multiplication with 1 sample at the sampling rate which is, for a sampling rate of 48 kHz approximately 20.8 μs. Other sets of prime numbers are possible without limitation.

When referring, for example, to FIG. 4, the gain factor g of the Allpass filter may be adapted to a value of 0.7 within a tolerance range of, for example, ±20%, 10% or ±5%. However, the gain value may also have a negative value of, e.g., −0.7 within the mentioned tolerance range. That is, the gain factor may be adapted to a value with a magnitude of 0.7 within the tolerance range.

In other words, additionally to the serial out pass configuration of FIG. 4, also a nested configuration in which the delay element of an outer Schroeder Allpass is replaced by another inner Allpass configuration or a combination of both configurations may be implemented. FIG. 5 shows a simple nested Allpass filter stage.

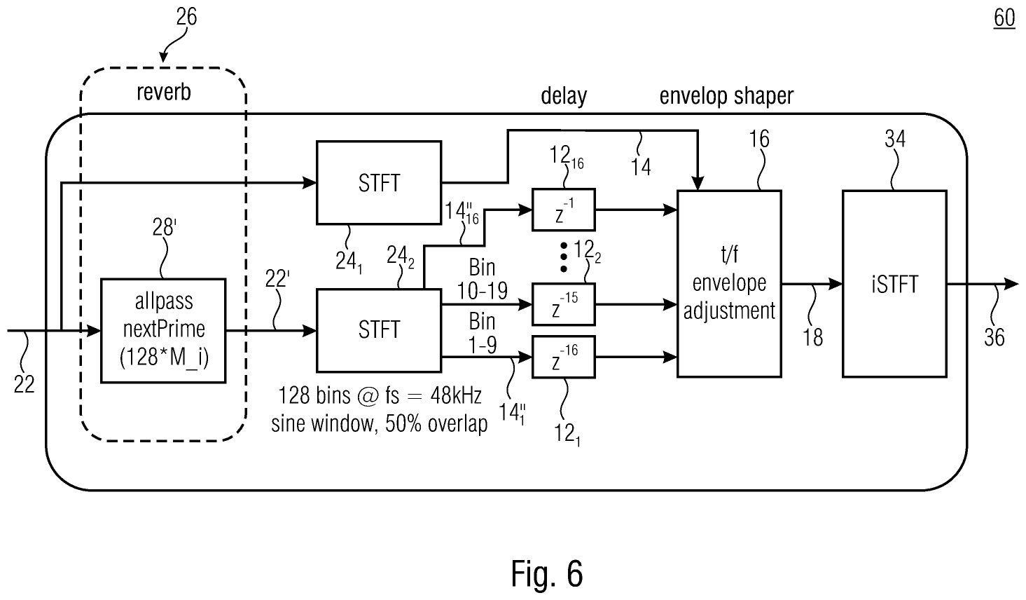

FIG. 6 shows a schematic block diagram of a decorrelator 60 according to an embodiment. The decorrelator 60 comprises the phase shifter 26 configured to operate in the time domain. An Allpass filter structure 28′ may be configured for using the respective next prime numbers when compared to the sets of prime numbers as described in connection with decorrelator 20 and/or 30. For ensuring a precise operation of decorrelator 60 same may comprise conversion units 24₁ and 24₂. Whilst conversion unit 24₁ may provide for the frequency representation of the audio signal, conversion unit 24₂ may receive the reverberated or phase shifted audio signal 22′ provided by the phase shifter 28′. The obtained parts 14″₁ to 14″₁₆ may be delayed by delay units 12₁ to 12₁₆ arriving at a comparable input for the envelope shaper 16 when compared to the decorrelator 20 and/or 30 whilst allowing for a time-domain based reverberation. That is, the parts of the frequency representation may form parts of the frequency representation from the reverberated audio signal 22′.

According to embodiments, a decorrelator as described herein may be combined with further functionality, i.e., the output signal can be further processed.

In other words, FIG. 6 shows an alternative implementation of a decorrelator with regard to FIG. 2.

Further, the inventive decorrelators may be combined with transient handling processing. Transients may cause artifacts in the decorrelated stereo signal such as post-echoes or unwanted panning effects. To mitigate this, a transient handling can be combined with the decorrelator described herein. Transient handling may mute the decorrelator output to preserve the direct onset waveform and suppress the post-echo caused by the pre-delay.

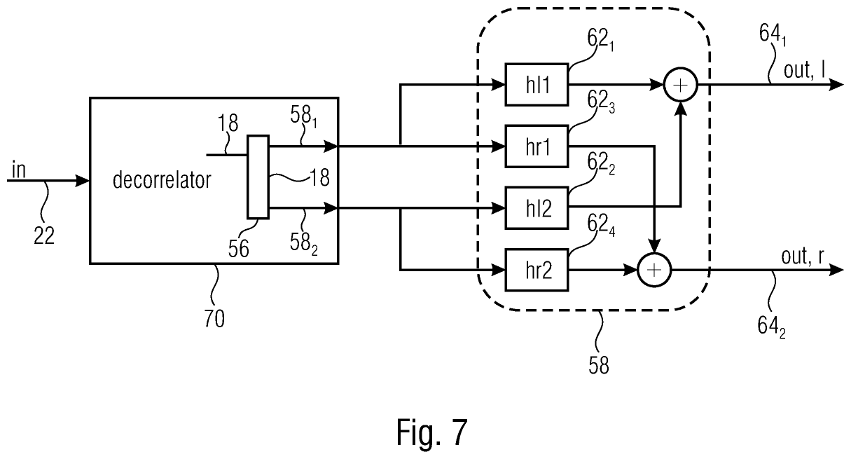

FIG. 7 shows a schematic block diagram of a decorrelator 70 according to an embodiment. Decorrelator 70 comprises at least a part of decorrelator 10, wherein alternatively or in addition at least parts of decorrelator 20, 30 and/or 60 may be arranged. Decorrelator 70 may comprise a signal processing stage 56 configured for processing the combined shaped frequency representation 18 or a signal based thereon. The combined shaped frequency representation 18 may be considered as a mono signal, i.e., it may represent a single channel. From the received mono signal the processing stage may provide at least signals 58₁ and 58₂ representing a stereo signal.

A source extender 58 that models the perceptual effect of a spatially extended sound source from a mono signal of a point source and a decorrelated version thereof may be coupled to the decorrelator 70. The source extender 58 may comprise filters 64₁ to 64₂ allowing for a source extend modelling based on the stereo signal having signals 58₁ and 58₂. The source extend modeling may be performed, for example, in the frequency domain and may result in stereo output signals 64₁, e.g., a left channel and 64₂, e.g., a right channel. It should be noted that the source extender 58 may also form a part of the decorrelator 70.

In other words, FIG. 7 shows a schematic block diagram of source extent processing.

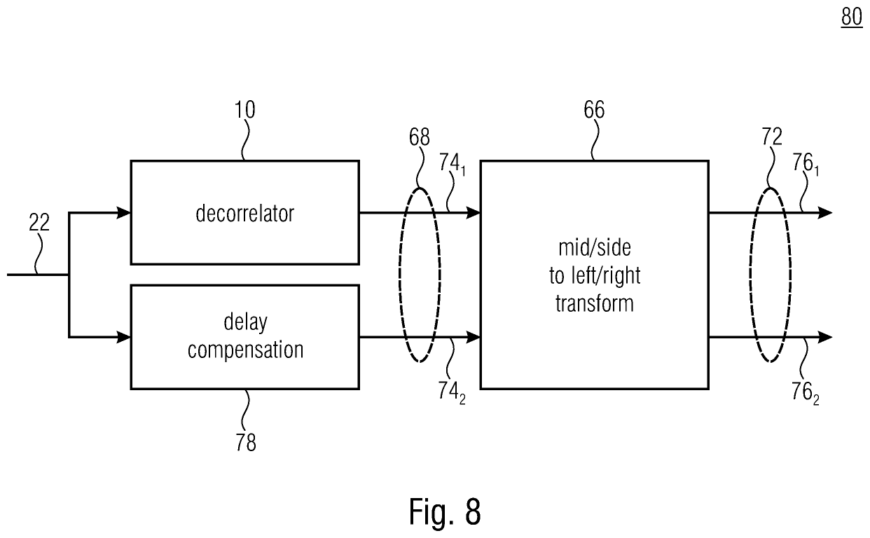

FIG. 8 shows a schematic block diagram of a processing system 80 according to an embodiment. Processing system 80 may comprise decorrelator 10. Alternatively or in addition, decorrelator 20, 30, 60 and/or 70 may be arranged. The processing system 80 comprises a processing stage 66 configured for transforming a mid/side decomposed signal 68 to a left/right decomposed signal 72. That is, the mid/side decomposed signal 68 may comprise at least a first signal 74₁, e.g., representing one of the mid/middle or side portion and a second signal 74₂ representing the other portion. The processing stage 66 may be configured for transforming the signals 74₁ to 74₂ and possibly additional signals into at least signals 76₁ to 76₂ representing a left channel and a right channel. One channel, e.g., the left channel L, may be obtained, for example, by adding the mid component M and the side component M+S; whilst the other, e.g., right channel may be obtained by subtracting one component from the other e.g., M−S. According to a different approach both channels may be obtained by using 50% or a factor of 0.5 thereof, i.e., 0.5(M+S) and 0.5(M−S). Other factors and/or determination rules are possible.

According to an embodiment, signal 74₁ is provided by the decorrelator of the processing system 80. The other signal 74₂ may be provided by a delay compensation unit 78 that is connected in parallel to the decorrelator 10 and is configured for also receiving the audio signal 22. The delay compensation unit 78 is, thus, connected with the processing stage 66. The delay compensation unit 78 may be configured for providing a time delay that is comparable to the decorrelator. Advantageously, for frequency domain embodiments, the delay equals the processing delay introduced by the STFT analysis/synthesis of the decorrelator. However, the decorrelator 10 may provide for additional signal processing leading to a decorrelation such that the signal 74₂ may comprise a similar delay when compared to signal 74₁. According to an embodiment, the signal 74₂ may be unprocessed with exception of the time delay.

The decorrelator 10 in the processing system 80 may provide the combined shaped frequency representation as at least one part of the mid/side decomposed signal to the processing stage 66. The processing stage 66 may transform the combined shaped frequency representation together with delay signal 74₂ to the left/right decomposed signal in the frequency domain. The output of the processing stage 66 may be a L/R signal 72. The decorrelator 10 itself may produce a mono signal S (Side, component 18), in that respect it is only part of it. With the transient handling, the direct part M (74₂; 74′₂) and the decorrelator output S (Signal 18) may become closely coupled, since the signal S will be muted and be “replaced” by an amplified M signal (Signal 74′₂). As a consequence, both units, decorrelator and “upmixing unit” 66 are closely coupled and so processing stage 66 finally provides the decorrelated stereo signal. If the decorrelator would be operated standalone with mono output, e.g., without processing stage 66, then delay compensated direct signal, without any scaling, should be added directly to the mono output to fill the muted gap and provide a “complete” signal.

In other words, FIG. 8 shows a decorrelator in M/S to L/R setup with delay compensation of mono (mid-signal) input.

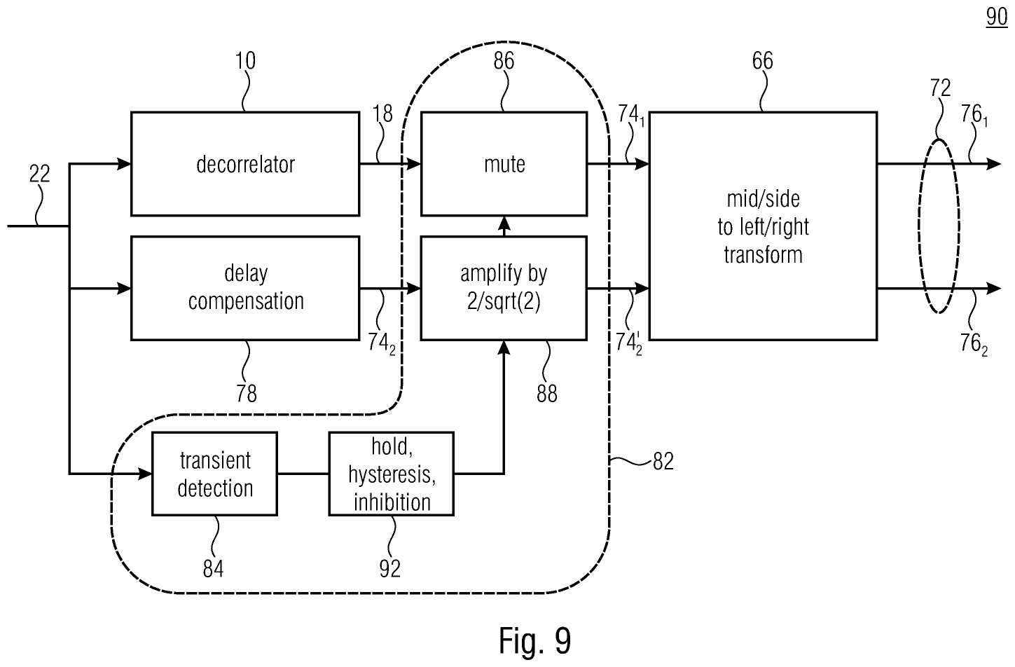

FIG. 9 shows a schematic block diagram of a processing system 90 according to an embodiment. When compared to the processing system 80, the processing system 90 comprises a transient suppressor 82 configured for detecting a transient in the audio signal 22 or the frequency representation 14 thereof at an input of the decorrelator. The transient suppressor may comprise a transient detection unit 84 configured for receiving the audio signal 22 or the frequency representation thereof. The transient detection unit 84 may detect a transient in the audio signal, e.g., by processing the audio signal 22. The transient suppressor 82 may further comprise a mute unit 86 configured for receiving the combined shaped frequency representation 18 and for muting the same based on a control signal. However, it is to be noted that a same or comparable effect may also be obtained when controlling the decorrelator 10 or the decorrelator contained in the processing system 90 so as to mute the output of the decorrelator. That is, the mute unit 86 may also form a part of the decorrelator. However, signal 74₁ forming the input of the processing stage 66 may be muted based on a detected transient in the audio signal 22. The transient suppressor 82 may be configured for temporarily muting the portion provided by the decorrelator to suppress echoes at the processing stage 66, wherein the echoes may relate to pre-echoes and/or post-echoes. When operating in the time domain, a window may be used for a soft muting to avoid additional transients to be caused by the muting. If done in the frequency domain, the STFT windowing being described in connection with decorrelators 20, 30 and 60 may provide for such an effect automatically, i.e., in a synergetic manner.

With regard to the processing stage 66, muting the output of the decorrelator 10 might lead to an unwanted shift in the input energy of the signal processing stage 66. To avoid negative effects an amplifier 82 may be connected between the delay compensation unit 78 and the signal processing stage 66 to temporarily amplify the signal 74₂ to obtain amplified signal 74′₂. Amplification of signal 74₂ may be conditional to muting the output of the decorrelator 10. That is, the transient suppressor 82 may be configured for amplifying the portion of the delay compensation unit 78 corresponding to muting the portion of the decorrelator.

A level of amplification may be fixed or may be controlled. According to one example, if applied, the amplification factor of amplifier 82 may be a factor of

$$\frac{2}{\sqrt{2}}$$

when compared to an unmuted portion of the decorrelator. That is, when muting the output of the decorrelator, the amplifier 88 may amplify signal 74₂ by

$$\frac{2}{\sqrt{2}}$$

whilst not amplifying signal 74₂ during times where the mute is off, i.e., g=1.

Optionally and to avoid unwanted effects during the transient suppression, the transient suppressor 82 may be configured for suppressing a detected transient in the audio signal and for suppressing a following transient not earlier than a predefined inhibition time. For example, the transient suppressor 82 may comprise a control unit 92 configured for controlling and/or applying a hold time, a hysteresis and/or an inhibition time. For example, the hold time may be shorter when compared to the inhibition time. The hold time may relate to a time during which the output of the decorrelator 10 is muted responsive to a detected transient, i.e., a property determined by the transient detection unit 84. The inhibition time may be longer when compared to the hold time, to avoid unwanted effects. For example, the hold counter, i.e., the time for muting, may be 1, 2, 4, 6, 7 or 8 blocks, whilst the inhibition time may be at least twice the time, e.g., at least 14, at least 20, at least 30 or 56 blocks or any other time duration.

According to an example, the control unit 92 may also provide for a hysteresis to mitigate on/off toggling of transient suppression for audio signals like low rate pulse trains. That is, the inhibition time provided by the control unit 92 may be a first inhibition time. The transient suppressor 82 may be configured for restarting the inhibition time as a second inhibition time being longer than the first inhibition time in case a transient occurs during the first inhibition time. That is, even if the hold time has lapsed but the inhibition time has not yet lapsed and in case a new transient is determined (regardless if the hold time has lapsed or not) the inhibition timer may be restarted. Optionally, the restarted inhibition timer may be longer when compared to the cancelled inhibition timer. In other words, when a very first transient is detected, then a hold counter and an inhibit counter are both started. The transient may be muted until the hold counter has reached its stop count, e.g., 8 blocks. Then, the hold counter may be reset and muting may stop. The inhibit counter may reach its stop count/reset much later in time, e.g., 56 blocks. If during said ongoing inhibit counting process a new transient is detected, then just the inhibit counter is restarted, but with a higher stop count value, e.g., 64 blocks. In this way, hysteresis is implemented by conditional switching and stop count modifications. That is, during the inhibit counter running, a new triggering of transient suppression or muting may be deactivated.

The transient suppressor 82 may be configured for operating in the frequency domain. Alternatively or in addition, the transient suppressor 82 may be configured for muting the portion of the decorrelator for a longer time when compared to a pre-delay of the decorrelator. That is, in case a transient is detected in the audio signal 22, then the mute should still be in effect when the transient arrives at the output of the decorrelator.

In other words, decorrelators according to embodiments operate in the short time Fourier transform (STFT) domain on overlapping transform blocks with short duration. This enables a small processing delay of a few milliseconds, e.g., 2.7 milliseconds assuming a transform size of 256 and 48 kHz sample rate, as opposed to the high delay of the PS/MDS decorrelator as described in [2] or [3] that may arrive at a delay time of 13.3 milliseconds at 48 kHz sample rate. Moreover, the described decorrelators can be implemented using very low computational Allpass filters and may therefore be computationally much more efficient than time domain decorrelation as described in [1] or [2]. If further downstream spectral processing is required or wanted, e.g., a source extent modelling, the described decorrelators may be interfaced directly to this processing stage in the STFT domain to achieve low computational complexity.

Decorrelators as described herein may thus provide for a short processing delay and a moderate computational complexity. Decorrelators can be combined with additional downstream processing to model audio objects having a spatial dimension, the so-called Spatially Extended Sound Sources (SESS) with a perceptual property of “Source Extend”.

In other words, FIG. 2 and FIG. 9 show advantageous embodiments of the present invention. First, the input signal or audio signal (sound of a point source, for example) may be fed into the decorrelator 20 comprising a time-block-wise DFT with, e.g., 256 sample block length and, e.g., 50% overlap. Next, the spectral bins of the DFT are time-delayed for a frequency dependent duration, where low frequencies may have a higher delay and high frequencies may have a lower delay. For example, delay may be 16 subband samples (42.7 milliseconds at 48 kHz) for low frequencies and may decrease down to 1 subband sample for the highest bins, i.e., z⁻¹. The decrease in delay over time may be linear, logarithmic or otherwise with rounding to integer numbers of subband samples. Next, each bin is sent through an Allpass filter, advantageously comprising a chain of simple Allpass filters or a nested Allpass filter structure. An example Allpass filter is shown in FIG. 4. A different structure is shown in FIG. 5. With regard to FIG. 4, one possible chain may comprise or consist of four such Allpass filters. The parameter g may be chosen to be, for example, 0.7 and the delays Mᵢ may be prime numbers. Note that FIG. 4 shows the very first part of the chain, i.e., M₁. As these filters may operate on downsampled spectral bands, e.g., downsampling factor 128, the delays may be very low, e.g., prime numbers 1, 2, 3 and 5 or, as another example, 1, 3, 5 and 7. Following, a time/frequency envelope shaping may be applied. Input signals to the envelope shaping may be the DFT bins directly and their delayed and filtered versions. Finally, an IDFT with overlap add may synthesize the output signal. The output signal may be further processed in time domain to obtain a left/right stereo signal from a mono input signal in a configuration as shown in FIG. 8. Alternatively, the left/right stereo signal can be assembled in DFT frequency domain and further processed in frequency domain, e.g., for a source extent/SESS modelling by fast convolution, if beneficial for overall computational efficiency. A configuration for source extent modelling is shown in FIG. 7. In contrast to other embodiments, the alternative embodiment having delays Mᵢ may be chosen as prime numbers being approximately 128 times (corresponding the aforementioned downsampling factor) larger than the ones chosen in subband domain, e.g., 131, 257, 383 and 641 (for the set of prime values 1, 2, 3 and 5) or 131, 383, 641 and 907 (for the set of prime values 1, 3, 5 and 7). For different sets of prime values with a different number of prime numbers and/or different prime numbers, corresponding values may be chosen. Further, the alternative embodiment may require an additional STFT to obtain the direct signal input to the time/frequency envelope shaper.

FIG. 9 shows an example decorrelator in M/S to L/R setup with transient handling processing. Aspects of these embodiments are:
A transient detection detects the presence of an isolated transient
If a transient is detected, the decorrelated sound is muted for a “hold time” and the delay compensated direct signal is amplified accordingly. To compensate for the effect of coherent addition, a factor of 2/sqrt(2) is applied to amplify the direct signal where it replaces the decorrelated signal
To avoid triggering on rapid pulse trains, that are perceived as tones, an inhibition prevents triggering by the next transient for a certain “inhibition time”; the inhibition time is restarted by each new transient detection during “hold time”
A hysteresis prevents toggling of transient detection (e.g. by increasing “inhibition time” in case of re-triggered inhibition)
Transient detection, muting, direct sound amplification, detection inhibition and hysteresis may be advantageously implemented in the STFT domain:
   STFT block overlap provides smooth cross-fade
   Mute time is longer than pre-delay of decorrelator
   Mute block counter to mute decorrelated signal and amplify direct signal
   Inhibit block counter to inhibit transient detection
   Hysteresis to avoid toggling in transient detection

Embodiments of the present invention relate to
An/a apparatus/method for decorrelation of an audio signal
   Decorrelator, including
      A DFT/IDFT pair (optional, if directly interfaced with SESS processing in frequency domain)
      Delays in subband domain; advantageously low frequencies have a higher delay and high frequencies have a lower delay; delay distribution along frequency: linear, logarithmic, etc.
      Allpass filters in subband domain; optionally: low frequencies can have a higher delay/order and high frequencies have a lower delay/order; higher order allpass filters may be realized by a stage of low-order allpass filters
         Short Schroeder IIR filters in (downsampled) DFT subband domain using small integer delay prime numbers in combination with frequency variant delays
      T/F envelope adjuster with high time resolution (<4 ms) working in the subband domain; measuring energy before and after delay/allpass processing; adjusting the energy of the subband signal to (as far as possible) match the energy of the original subband signal.
   Low delay decorrelator as part of “source extent” modeling/processing (as opposed to MPEG Surround decorrelator)
   Interface to downstream source extent processing in time or DFT frequency domain for computational efficiency
   Alternative implementation: Allpass filters before delays (“post-delays”)

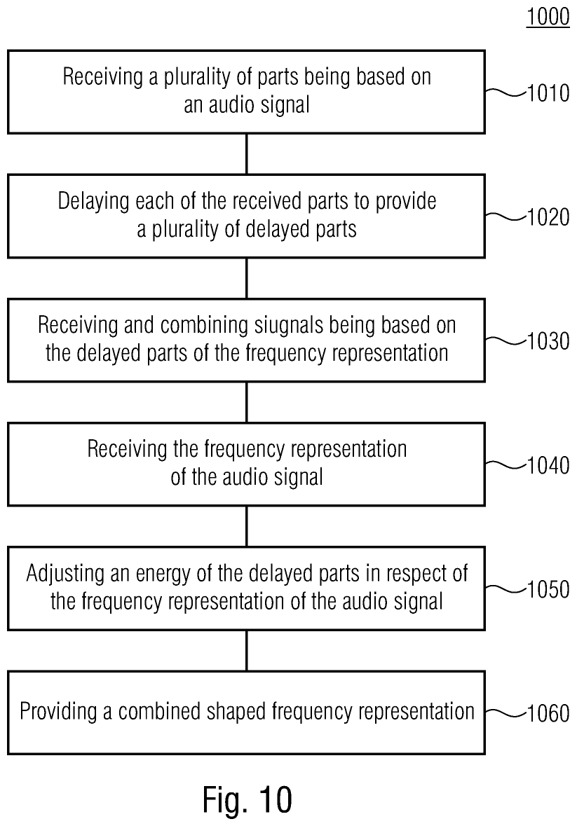

FIG. 10 shows a schematic block diagram of a method 1000 according to an embodiment that may be implemented, for example, by a decorrelator described herein. Method 1000 comprises a step 1010 in which a plurality of parts that are based on an audio signal are received. In 1020 each of the received parts is delayed to provide for a plurality of delayed parts. 1030 comprises receiving and combining signals being based on the delayed parts of the frequency representation. 1040 comprises receiving the frequency representation of the audio signal. 1050 comprises adjusting an energy of the delayed parts in respect of the frequency representation of the audio signal. 1060 comprises providing a combined shaped frequency representation, e.g., using the envelope shaper 16.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

The inventive encoded audio signal can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

### REFERENCES

[1] W. Oomen, E. Schuijers, B. den Brinker, and J. Breebaart, “Advances in Parametric Coding for High-Quality Audio,” Paper 5852, (2003 March.)
[2] J. Breebaart, S. van de Par, A. Kohlrausch, and E. Schuijers, “High-quality Parametric Spatial Audio Coding at Low Bitrates,” Paper 6072, (2004 May.)
   QMF domain PS:
[3] H. Purnhagen, J. Engdegard, J. Roden, and L. Liljeryd, “Synthetic Ambience in Parametric Stereo Coding,” Paper 6074, (2004 May.)
[4] J. Herre, K. Kjörling, J. Breebaart, C. Faller, S. Disch, H. Purnhagen, J. Koppens, J. Hilpert, J. Rödén, W. Oomen, K. Linzmeier, and K O. S E. Chong, “MPEG Surround—The ISO/MPEG Standard for Efficient and Compatible Multichannel Audio Coding,” J. Audio Eng. Soc., vol. 56, no. 11, pp. 932-955, (2008 November.)

1. A decorrelator comprising:
a plurality of delay units, wherein each delay unit is configured for receiving a part of a frequency representation being based on an audio signal; wherein each delay unit is configured for delaying the received part to provide a delayed part; and
an envelope shaper configured for receiving and combining signals being based on the delayed parts of the frequency representation; for receiving the frequency representation of the audio signal; for adjusting an energy of the delayed parts in respect of the frequency representation of the audio signal; and for providing a combined shaped frequency representation.

2. The decorrelator of claim 1, wherein different parts of the frequency representation comprise a same or a different number of frequency bins.

3. The decorrelator of claim 1, further comprising a phase shifter configured for phase shifting the frequency representation of the audio signal; or for phase shifting the audio signal in a time domain to acquire a phase shifted audio signal.

4. The decorrelator of claim 3, wherein the phase shifter is configured for phase shifting the frequency representation of the audio signal and comprises a plurality of allpass filters, wherein each allpass filter is configured for phase shifting an associated part of the frequency representation of the audio signal.

5. The decorrelator of claim 4, wherein an allpass filter of the plurality of allpass filter comprises a set of allpass filter structures such as Schroeder IIR filters, being serially connected to each other; wherein the allpass filter structures are adapted for providing different time delays; or
wherein the allpass filter structures comprise a nested allpass filter structure.

6. The decorrelator of claim 5, wherein a number of allpass filter structures and/or a circuitry of the allpass filter structure is equal or different between different allpass filters.

7. The decorrelator of claim 5, wherein the different time delays are based on a prime number multiple of a local sampling rate used for acquiring the frequency representation of the audio signal.

8. The decorrelator of claim 5, wherein the set of allpass filter structures comprises a number of four allpass filter structures and are adapted for providing a delay of 1, 2, 3 and 5 or 1, 3, 5 and 7, respectively.

9. The decorrelator of claim 4, wherein a gain factor of the allpass filter is adapted to a value with a magnitude of 0.7 within a tolerance range of e.g., 20%.

10. The decorrelator of claim 3, wherein the phase shifter is configured for phase shifting the audio signal in a time domain; wherein the phase shifter comprises a set of allpass filter structures such as Schroeder IIR filters, being serially connected to each other;
wherein the allpass filter structures are adapted for providing different time delays; or
wherein the allpass filter structures comprise a nested allpass filter structure.

11. The decorrelator of claim 10, wherein the different allpass time delays are based on a prime number multiple of a reciprocal of a sampling rate used for acquiring the frequency representation of the audio signal.

12. The decorrelator of claim 10, wherein the different time delays are based on a prime number being acquired by multiplying each of a set of minimal prime numbers, e.g., 1, 2, 3 and 5; or 1, 3, 5 and 7, with a downsampling factor used for generating the parts of the frequency representation of the audio signal to acquire an intermediate result; and for using a next prime number with respect to the intermediate result, e.g., as 131, 257, 383, 641 or 131, 383, 641, 907.

13. The decorrelator of claim 10, comprising a first conversion unit for acquiring the frequency representation of the audio signal from the audio signal for the envelope shaper; and comprising a second conversion unit for acquiring a frequency representation from the reverberated audio signal; wherein the parts of the frequency representation form parts of the frequency representation from the reverberated audio signal.

14. The decorrelator of claim 1, wherein the parts of the frequency representation comprise an equal or different number of frequency bins.

15. The decorrelator of claim 1, being adapted for acquiring a number of 16 parts of the frequency representation.

16. The decorrelator of claim 1, being adapted for acquiring the frequency representation with a number of 128 or 129 frequency bins.

17. The decorrelator of claim 1, wherein the decorrelator is adapted to additionally implement a same and predefined delay for a subset or all parts of the frequency representation.

18. The decorrelator of claim 1, wherein the delay units associated to a spectral part of the plurality of delay units are configured for delaying the associated part of the frequency representation differently when compared to delay units associated to other spectral parts.

19. The decorrelator of claim 1, wherein the plurality of delay units is configured for delaying parts of the frequency representation comprising lower frequencies with a higher time delay when compared to parts of the frequency representation comprising higher frequencies.

20. The decorrelator of claim 19, wherein a relationship between different time delays is one of linear, logarithmic and/or based on a rounding on subband samples.

21. The decorrelator of claim 1, comprising a conversion unit for receiving and converting the audio signal or a reverberated version of the audio signal into the parts by performing a time-block-wise discrete Fourier transform, DFT, or Short-time Fourier transform, STFT; wherein the conversion unit is configured for converting blocks with an overlap of 50% within a tolerance range.

22. The decorrelator of claim 1, comprising a conversion unit for receiving and converting the audio signal or a reverberated version of the audio signal into the parts by performing a time-block-wise discrete Fourier transform, DFT, or Short-time Fourier transform, STFT; wherein blocks comprise a block length of 256 samples.

23. The decorrelator of claim 1, comprising an inverse conversion unit for receiving processed versions of the parts of the frequency representation and for synthesizing an synthesized signal from the processed versions based on an overlap add procedure.

24. The decorrelator of claim 1, wherein the envelope shaper is configured for operating in a subband domain and with a temporal resolution of less than 4 ms.

25. The decorrelator of claim 1 comprising an interface for providing a signal based on the combined shaped frequency representation.

26. The decorrelator of claim 1, wherein the envelope shaper is to shape spectral bins in time and/or in frequency individually or as a group, e.g., by implementing an interdependent or an at least groupwise common shaping processing.

27. The decorrelator of claim 1, comprising a signal processing stage configured for receiving a signal based on the combined shaped frequency representation as a mono signal and for processing the mono signal at least to a stereo signal.

28. The decorrelator of claim 1, comprising a signal processing stage configured for processing the combined shaped frequency representation at least to a stereo audio signal; and for source extend modelling based on the at least stereo signal, e.g., in the frequency domain.

29. Processing system comprising:
a decorrelator according to claim 1; and
a processing stage for transforming a mid/side decomposed signal to a left/right decomposed signal.

30. The processing system of claim 29, wherein one portion of the mid/side decomposed signal is provided by the decorrelator and the other portion is provided by a delay compensation unit being connected in parallel with the decorrelator and connected with the processing stage.

31. The processing system of claim 30, comprising a transient suppressor configured for detecting a transient in the audio signal or the frequency representation thereof at an input of the decorrelator;
wherein the transient suppressor is configured for temporarily muting the portion provided by the decorrelator to suppress echoes at the processing stage.

32. The processing system of claim 31, wherein the transient suppressor is configured for amplifying the portion of the delay compensation unit corresponding to muting the portion of the decorrelator.

33. The processing system of claim 32, wherein the transient suppressor is configured for amplifying the portion of the delay compensation unit by a factor of
$$\frac{2}{\sqrt{2}}$$
when compared to an unmuted portion of the decorrelator.

34. The processing system of claim 31, wherein the transient suppressor is configured for suppressing a detected transient and for suppressing a following transient not earlier than a predefined inhibition time.

35. The processing system of claim 31, wherein the inhibition time is a first inhibition time; wherein the transient suppressor is configured for restarting the inhibition time as a second inhibition time being loner than the first inhibition time in case a transient occurs during the first inhibition time.

36. The processing system of claim 31, wherein the transient suppressor is configured for operating in the frequency domain.

37. The processing system of claim 31, wherein the transient suppressor is configured for muting the portion of the decorrelator for a longer time when compared to a pre-delay of the decorrelator.

38. The processing system of claim 29, wherein the decorrelator is to provide the combined shaped frequency representation as a part of the mid/side decomposed signal to the processing stage; and the processing stage is to transform the combined shaped frequency representation and a delayed version of the audio signal to the left/right decomposed signal in the frequency domain.

39. A method comprising:
receiving a plurality of parts of a frequency representation being based on an audio signal;
delaying each of the received parts to provide a plurality of delayed parts; and
receiving and combining signals being based on the delayed parts of the frequency representation;
receiving the frequency representation of the audio signal;
adjusting an energy of the delayed parts in respect of the frequency representation of the audio signal; and
providing a combined shaped frequency representation.

40. The method of claim 39, further comprising:
detecting a transient in the audio signal or the frequency representation thereof;
temporarily muting a portion provided by a decorrelator to suppress echoes at a processing stage.

41. A non-transitory digital storage medium having a computer program stored thereon to perform the method comprising:
receiving a plurality of parts of a frequency representation being based on an audio signal;
delaying each of the received parts to provide a plurality of delayed parts; and
receiving and combining signals being based on the delayed parts of the frequency representation;
receiving the frequency representation of the audio signal;
adjusting an energy of the delayed parts in respect of the frequency representation of the audio signal; and
providing a combined shaped frequency representation,
when said computer program is run by a computer.
